(19) United States
(12) Patent Application Publication
(10) Pub. No.: US 2005/0028200 A1
(43) Pub. Date: Feb. 3, 2005

(54) Media content navigation associated advertising

(76) Inventor: Esteban Sardera, San Francisco, CA (US)

Correspondence Address: LEE & HAYES PLLC, 421 W RIVERSIDE AVENUE SUITE 500, SPOKANE, WA, 99201, US

(21) Appl. No.: 10/632,301

(22) Filed: Aug. 1, 2003

(51) Int. Cl. H04N 5/445; H04N 7/16

(52) U.S. Cl. 725/42; 725/9; 725/39; 725/40; 725/43; 725/44; 725/46; 725/52; 725/60; 725/61

(57) ABSTRACT

In an implementation of media content navigation associated advertising, media content is rendered which can include a program and/or audio. When a media content navigation input is received, a navigation indicator is displayed and an advertisement can be rendered while the navigation indicator is displayed.

### TECHNICAL FIELD

This invention relates to advertising and, in particular, to media content navigation associated advertising.

### BACKGROUND

Client devices, such as digital video recorders, can be implemented to receive video content in the form of video on-demand entertainment, such as movies, and to receive broadcast and/or interactive television entertainment and information. A digital video recorder includes a hard disk memory so that a viewer can record the video content and other media content of interest to the viewer.

The advent of on-demand programming, such as with recorded or cached on-demand and broadcast media content, provides a viewer with the option to navigate a program with media content navigation features commonly referred to as “trick modes”. These navigation features are typically initiated with a remote control device and include commands such as fast-forward, skip-ahead in the program, jump to a next segment, pause the program, and the like.

A skip-ahead navigation control input from a viewer, while beneficial when used to shorten the time for viewing a program, enables the viewer to skip past advertisements that are broadcast between segments of the program. These advertisements for products and services are the primary source of revenue for a broadcaster of the media content. As more viewers attain the ability to skip past the advertisements in their programming choices, advertisers will be unwilling to have their advertising messages communicated in the traditional manner.

Accordingly, broadcasters need to provide alternate advertisement presentation techniques to deliver the advertising messages with media content so that the broadcasters may continue their sponsorship and advertising revenue model.

### SUMMARY

Media content navigation associated advertising is described herein.

In an implementation, media content is rendered which can include displaying a program for viewing and/or rendering audio. When a media content navigation input is received, a navigation indicator is displayed and an advertisement can be rendered while the navigation indicator is displayed. For example, the advertisement can be rendered as any type of an image, as audio, and/or any combination thereof.

### BRIEF DESCRIPTION OF THE DRAWINGS

The same numbers are used throughout the drawings to reference like features and components.

FIG. 1 illustrates an exemplary implementation of media content navigation associated advertising.

FIG. 2 further illustrates the exemplary implementation of media content navigation associated advertising shown in FIG. 1.

FIG. 3 illustrates an exemplary implementation of media content navigation associated advertising maintained within program guide data.

FIG. 4 illustrates an exemplary implementation of media content navigation associated advertising.

FIG. 5 is a flow diagram that illustrates an exemplary method for media content navigation associated advertising.

FIG. 6 illustrates various components of an exemplary client device implemented in a television-based system.

FIG. 7 illustrates an exemplary system architecture in which media content navigation associated advertising can be implemented.

FIG. 8 illustrates an exemplary broadcast video distribution architecture in which media content navigation associated advertising can be implemented.

### DETAILED DESCRIPTION

Media content navigation associated advertising systems and methods are described that provide advertisement presentation techniques to deliver advertising messages with media content. An advertisement associated with media content, such as a television program or a music presentation, can be rendered as an image, as a series or sequence of images, and/or as audio for a time duration during which a navigation indicator is displayed. Alternatively, an advertisement can be rendered as an image, as a series or sequence of images, and/or as audio in place of the navigation indicator, or as an audio or visual component of the navigation indicator.

For example, when a viewer of a television program skips-ahead in the programming to bypass commercial advertisements that are broadcast between segments of the program, a navigation indicator is displayed over the program to indicate that a media content navigation input has been received, and that the programming is being skipped. A navigation indicator may be displayed over the program to indicate that the programming has been paused, is being fast-forwarded, is being rewound, and the like. A broadcaster, or content provider, of the program or music presentation can deliver an advertising message that is rendered as a logo and/or as audio while the navigation indicator is displayed, or in place of the navigation indicator. A broadcaster can provide an advertisement associated with a navigation indicator and/or associated with media content navigation to identify that a particular program, or media content rendition, is sponsored by a particular advertiser, or advertisers.

The following discussion is directed to audio and/or graphics entertainment and information systems, as well as television-based entertainment and information systems, such as a two-way unicast network, interactive television networks, cable networks, and Web-enabled television networks. Client devices in such systems range from full-resource clients with substantial memory and processing resources, such as television-enabled personal computers and television recorders equipped with hard-disks, to low-resource clients with limited memory and/or processing resources, such as traditional set-top boxes that are also implemented to record broadcast programs. While aspects of the described systems and methods for media content navigation associated advertising can be implemented in any number of television-based entertainment and information systems, and within any number and types of client devices, the systems and methods are described in the context of the following exemplary system architectures.

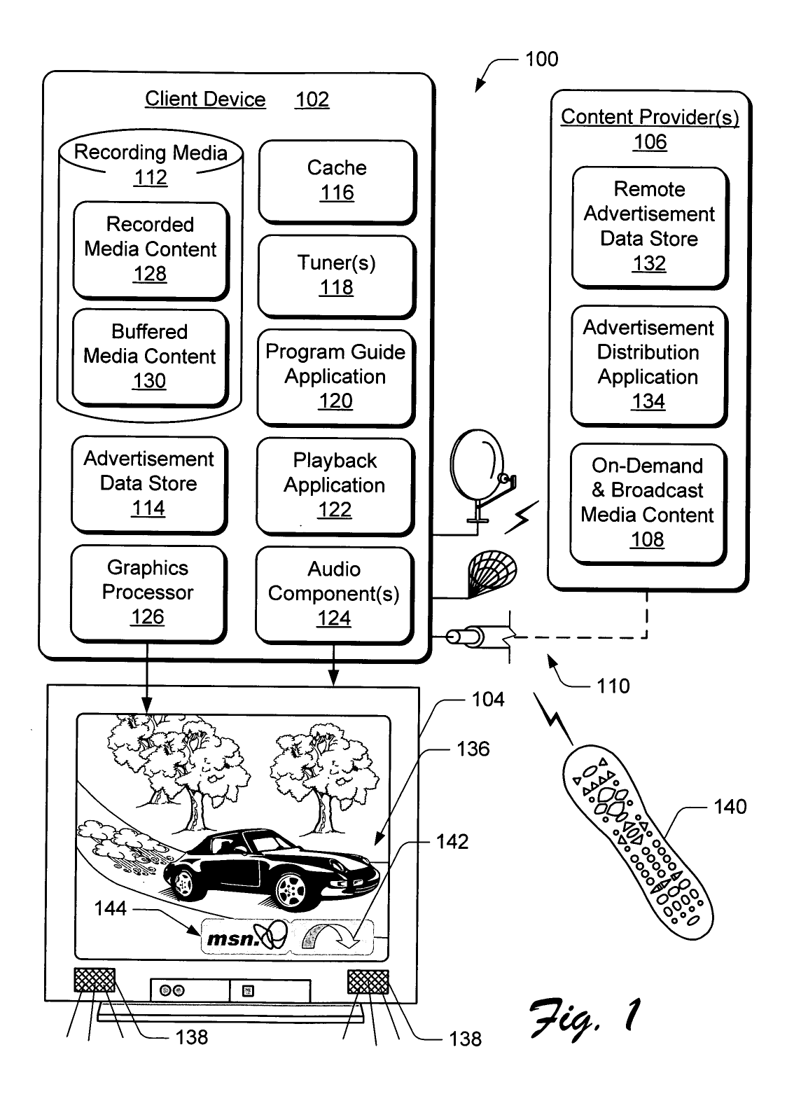

FIG. 1 illustrates an exemplary implementation 100 of media content navigation associated advertising. The exemplary implementation 100 is an example of a media content playback system that includes a client device 102, a display device 104, and one or more content providers 106 which may be a satellite operator, a network television operator, a cable operator, and the like. Content providers 106 control the distribution of on-demand and/or broadcast media content 108 such as movies, programs, commercials, music, and similar audio, video, and/or image content. Client device 102 receives the media content 108 via various transmission media 110, such as satellite transmission, radio frequency transmission, cable transmission, and/or via any number of other transmission media, such as a file transfer protocol over a network (e.g., Internet or Intranet) and/or data packet communication.

Client device 102 can receive the on-demand and/or broadcast media content, such as television programs, music, and the like, from a headend in a television-based content distribution system, for example, that provides the media content as well as program guide data to multiple client devices. Client device 102 can be implemented in any number of embodiments, such as a set-top box, a digital video recorder (DVR) and playback system, a digital audio recorder and playback system (e.g., an MP3 player), and as any other type of client device that may be implemented in an audio, graphic, or television-based entertainment and information system.

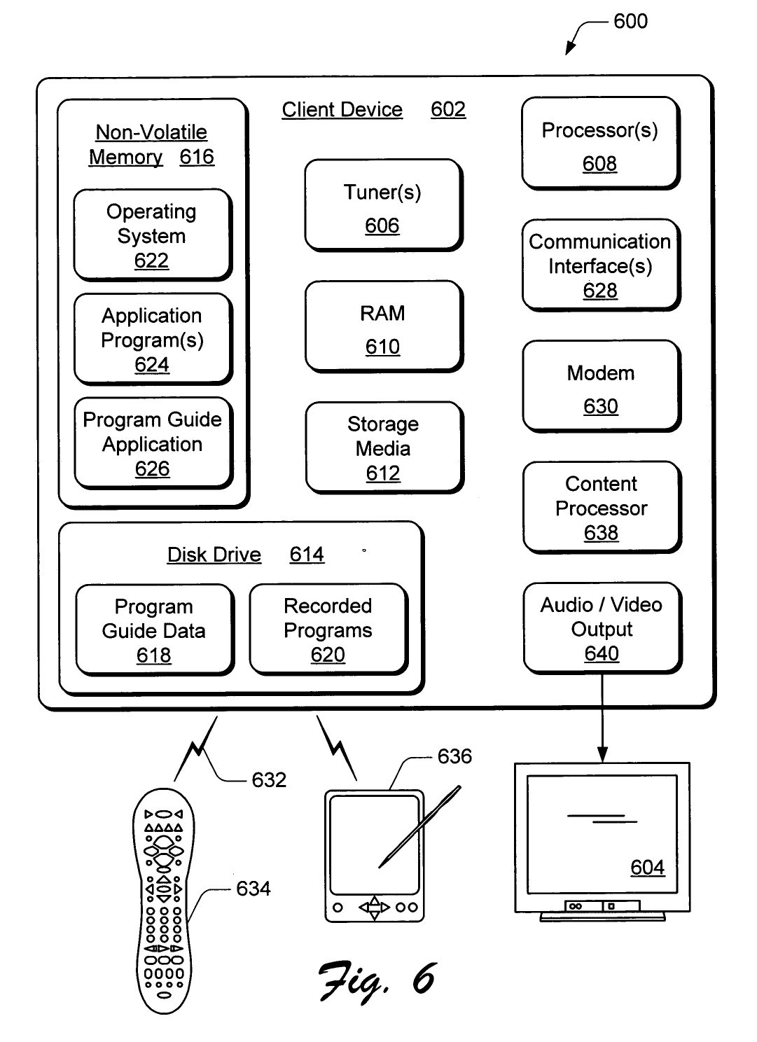

In this example, client device 102 includes memory components such as a recording media 112, an advertisement data store 114, and a cache 116. Client device 102 also includes one or more tuners 118, a program guide application 120, a playback application 122, one or more audio components 124, and a graphics processor 126. Although not shown in this example, client device 102 may be implemented with any number and combination of differing components as further described below with reference to FIG. 6.

The tuner(s) 118 can each be independently tuned to a different program channel to receive on-demand and/or broadcast media content 108 (e.g., videos, programs, music, and the like) which can be recorded and maintained with the recording media 112 as recorded media content 128. Recording media 112 can be implemented as any form of memory component, such as disk drive in a digital video recorder, for example. Further, recording media 112 includes a portion of memory allocated for buffered media content 130 which is buffered with a short-term content buffer that maintains segments of stored media received via transmission media 110. The received media content is buffered to maintain segments of the media content, such as the most recent thirty minutes, for example. A short-term content buffer is also referred to as a pause buffer to record the most recent segment of a paused broadcast program or on-demand video, and to playback the program or video for viewing from the beginning of the pause event when a viewer returns to continue watching the program or video.

As used herein, “programs” include news shows, sitcoms, comedies, movies, commercials, talk shows, sporting events, on-demand videos, music, digital music (e.g., audio only), and any other form of audio, graphic, and/or television-based entertainment and information. Further, “recorded programs” include any of the aforementioned “programs” that have been recorded and that are maintained with a memory component (e.g., recording media 110 in client device 102) as recorded programs 120, or that are maintained with a remote program data store (not shown) such as on a video-on-demand server. The “recorded programs” can also include any of the aforementioned “programs” that have been recorded and that are maintained at a broadcast center and/or at a headend that distributes the recorded programs to subscriber sites and client devices.

Advertisement data store 114 can be implemented as any form of a memory component to maintain, or otherwise store, advertisement data received via transmission media 110 from the one or more content providers 106. Although shown separately, the advertisement data store 114 can be maintained with the recording media 112 or as part of program guide application data also maintained with the recording media 112. For broadcast media content, such as a broadcast television program, the advertisement data corresponding to the program can be received as one or more data packets integrated with the live feed, or data stream, of media content. Alternatively, advertisement data can be received from the content provider(s) 106 as an independent broadcast or transmission.

The stored advertisement data corresponds to advertisements that include any form of an image, such as a still image, a sequence or series of images, a graphic, a logo, an animated logo, or a watermark, and any form of audio, such as music, digital music, an audible message, a generated tone, and/or any combination of an image and audio. The one or more content providers 106 include a remote advertisement data store 132 (e.g., one or more memory components not integrated with client device 102). The remote advertisement data store 132 maintains, or otherwise stores, the advertisement data that corresponds to the advertisements. The content provider(s) 106 also include an advertisement distribution application 134 that receives requests for advertisements from client device 102, and controls the distribution of advertisement data to client device 102.

Cache 116 is a memory component which can be implemented as random access memory (RAM) for faster access during data processing in client device 102. The cache 116 can maintain advertisement(s) that correspond to a program currently displayed on display device 104. Further, the cache 116 can maintain any form of an index to advertisement(s) or an advertisement playlist of one or more advertisements stored in the advertisement data store 116, or stored in the remote advertisement data store 132 at a content provider 106. Program guide application 120 and playback application 122 can be stored as computer-executable instructions in a non-volatile memory of client device 102.

Program guide application 120 is implemented to generate a program guide for display on display device 104. A program guide includes a program broadcast schedule which displays schedule information to indicate when a particular program will be broadcast for viewing and on which program channel the program will be broadcast or received. The program schedule information also associates each program with a time display that indicates a time of day when the program will be broadcast for viewing on a particular program channel.

Playback application 122 is implemented to control the playback of media content, such as a program 136 displayed on display device 104 and/or audio being rendered with an audio playback device, such as speakers 138 in display device 104. The one or more audio components 124 render an advertisement or audible portion of an advertisement as audio, such as music or a tone, and/or as an audible message, on speakers 138. Further, the playback application 122 is implemented to receive a media content navigation input, such as from a user-operated remote control device 140, to generate a navigation indicator 142 for display over, or on, the program 136, and to obtain an advertisement 144 to be rendered while the navigation indicator 142 is displayed. Alternatively, the advertisement 144 can be displayed in place of the navigation indicator 142, or as a visual component of the navigation indicator 142.

A media content navigation input can include a command to play media content (e.g., start a program for viewing or begin an audio rendition), skip-ahead or skip-back in the media content, pause or stop the media content, and any other similar media content navigation command. A navigation indicator is displayed that corresponds to the particular media content navigation input. For example, navigation indicator 142 is displayed on display device 104 and corresponds to a skip-ahead command in the program 136. Any different form or style of navigation indicator can be displayed that corresponds to each of the different media content navigation inputs.

The playback application 122 can obtain an advertisement, such as the logo advertisement 144 and/or an audio message, from the advertisement data store 114, the cache 116, and/or from the remote advertisement data store 132 in content provider 106. An advertisement associated with a particular program can also be maintained with the program guide data corresponding to the program. Although the program guide application 120 and the playback application 122 are each illustrated and described as single applications, program guide application 120 and playback application 122 can each be implemented as several component applications distributed to each perform one or more functions in a media content playback system. Further, although illustrated and described as two separate applications, the program guide application 120 and the playback application 122 can be implemented together as a single application.

The graphics processor 126 processes media content for display, such as program 136 displayed on display device 104. The graphics processor 126 also processes navigation indicator data to display navigation indicators on display device 104, and processes advertisement data to display graphic advertisements on the display device 104, such as logo advertisement 144, or an animated logo advertisement. A program can be processed for display as a digital MPEG image, for example, and the navigation indicators and graphic advertisements can be processed for display as on-screen images over the MPEG image. The graphics processor 126 can receive program MPEG frames from frame buffers and can receive on-screen image data for navigation indicators and advertisement logos from on-screen display buffers.

An advertisement associated with media content can be rendered (e.g., a graphic or logo displayed over a program and/or rendered as audio) for a time duration when a navigation indicator is displayed, or for some other definable time duration. In this example, advertisement logo 144 is displayed with navigation indicator 142 while a viewer of program 136 skips-ahead past regular broadcast advertisements that are broadcast between segments of the program. Further, an advertisement associated with a navigation indicator can be related to the regular broadcast advertisement that has been skipped over which the viewer can then back-up to view if the advertised message is of interest to the viewer.

With media content navigation associated advertising, a content provider, or broadcaster, can still deliver advertising messages with media content when advertisements that are broadcast for viewing with a program, for example, are skipped over by a viewer of the program. Further, an advertisement associated with a navigation indicator still provides the notion that a particular program, or media content, is sponsored by an advertiser, or advertisers.

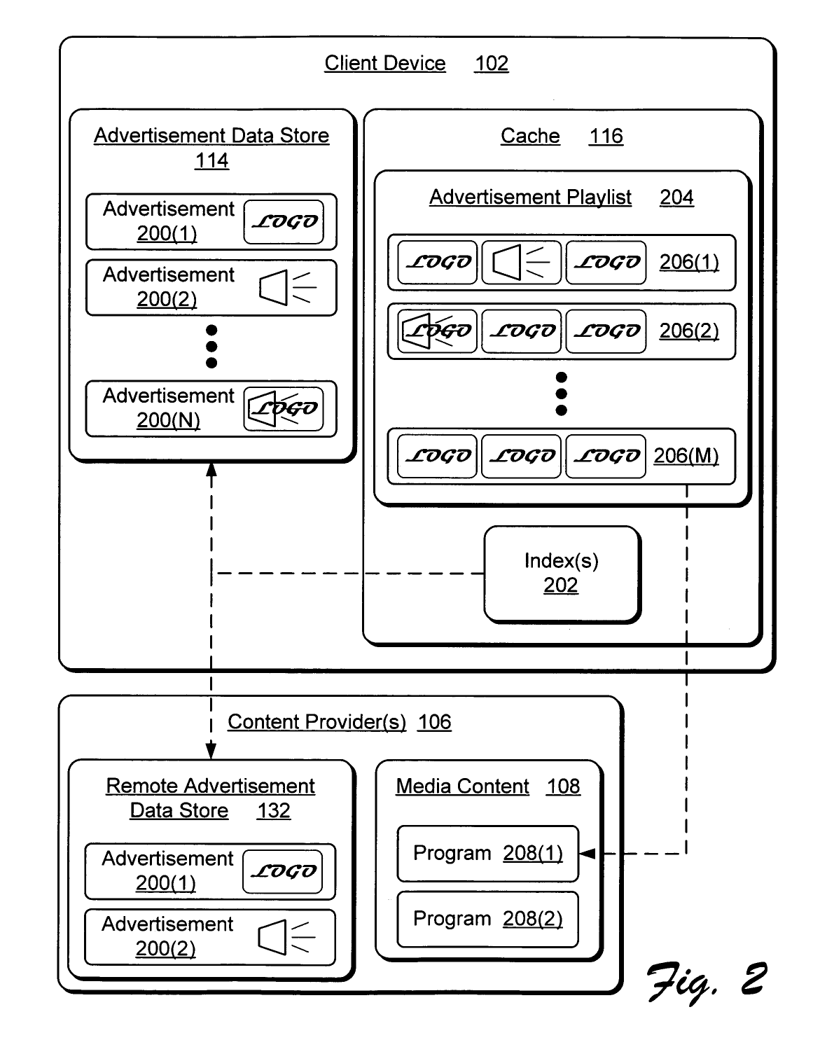

FIG. 2 further illustrates aspects of the exemplary implementation 100 of media content navigation associated advertising shown in FIG. 1. The advertisement data store 114 in client device 102 includes advertisements 200(1), 200(2), . . . , 200(N) which are received from a content provider 106. The same advertisements 200 can be located in the remote advertisement data store 132 in content provider 106. Advertisement 200(1) is an example of a logo advertisement that can be displayed with a navigation indicator, or in place of a navigation indicator, on a display device when a media content navigation input is received, such as logo advertisement 144 (FIG. 1). Advertisement 200(2) is an example of an audio advertisement that can be rendered with an audio playback device while a navigation indicator is displayed, or when the media content is navigated. Advertisement 200(N) is an example of an advertisement that includes both a graphic component (e.g., a logo) and an audio component. As described above, an advertisement can include any combination of an image such as a still image, a sequence or series of images, a graphic, a logo, an animated logo, or a watermark, and/or any form of audio, such as music, digital music, an audible message, a generated tone, and the like.

The cache 116 in client device 102 includes one or more indexes 202 to the advertisements 200 in the advertisement data store 114 and/or in the remote advertisement data store 132 in content provider 106. When a program 208 is distributed as media content 108 from content provider 106 to client device 102, an index 202 can be maintained in the cache 116 such that when a media content navigation input is received, the playback application 122 can utilize the index 202 to obtain an advertisement 200 that corresponds to the particular program 208. An index 202 to an advertisement can also be received and utilized to obtain an up-to-date advertisement from the remote advertisement data store 132 in content provider 106. Although not shown, the cache 116 can also maintain an advertisement 200 such that the playback application 122 can obtain the advertisement directly from the cache 116 when a media content navigation input is received.

The cache 116 also includes an advertisement playlist 204 that includes playlists 206(1), 206 (2), . . . , 206(M). A playlist 206 can correspond to a program 208 maintained for distribution as media content 108 at content provider 106. When a particular program 208 is distributed as media content 108 from content provider 106 to client device 102, a corresponding playlist 206 can be maintained in the cache 116 such that when a media content navigation input is received, the playback application 122 can utilize the playlist 206 to obtain advertisements 200 that correspond to the program 208. For example, when a first media content navigation input is received, a first advertisement 200(1) (e.g., a logo advertisement) corresponding to the first designated advertisement in playlist 206(1) can be displayed. When a second media content navigation input is received, a second advertisement 200(2) (e.g., an audio advertisement) corresponding to the second designated advertisement in playlist 206(1) can be rendered as audio. A playlist 206 can designate a particular order in which different advertisements 200 are to be rendered, or a playlist such as 206(M) can designate that the same advertisement be rendered each time a media content navigation input is received.

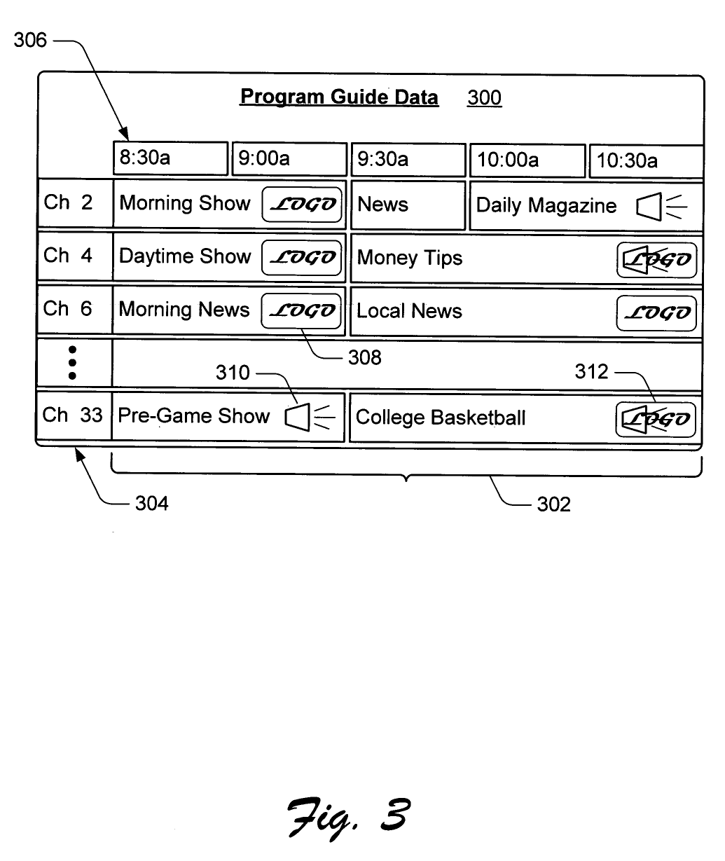

FIG. 3 illustrates program guide data 300 that includes media content associated advertisements. Program guide data 300 includes schedule information to indicate when any of the programs 302 will be broadcast for viewing and on which of the corresponding program channels 304 the programs 302 will be broadcast and/or received. The program schedule information also associates each program 302 with a time of day 306 when a particular program will be broadcast for viewing on a corresponding program channel 304.

In this example, program guide data 300 includes embedded, or integrated, advertisement data for advertisements that correspond to a particular program 302. For example, a logo advertisement 308 corresponds to a program “Morning News” scheduled for broadcast on program channel six (6) at 8:30 a.m., an audio advertisement 310 corresponds to a program “Pre-Game Show” scheduled for broadcast on program channel thirty-three (33) at 8:30 a.m., and an advertisement 312 that includes both a graphic component and an audio component corresponds to a program “College Basketball” scheduled for broadcast on program channel thirty-three (33) at 9:30 a.m.

Although the program guide data 300 only includes a few program channels (e.g., 2, 4, 6, . . . 33), the program guide data 300 can typically include programming information for any number of program channel numbers and associated program listings. Further, although the programs 302 are each shown to have only one associated advertisement, such as embedded advertisements 308, 310, and 312, each of the programs 302 can include any number and type of associated advertisement. For example, a program 302 can include an embedded advertisement playlist 206 (FIG. 2), or a reference to an advertisement playlist that associates multiple advertisements with a program.

When a program 302 is distributed as media content 108 (FIG. 1) from content provider 106 to client device 102, and when a media content navigation input is received, the playback application 122 can obtain an advertisement such as 308, 310, and 312 from the program guide data 300 that corresponds to a program being displayed for viewing. Further, the playback application can obtain an advertisement corresponding to a particular program based on any one or combination of a time of the day, a type of the program, and a program channel on which the program is broadcast. In an event that a program is recorded and maintained as recorded media content 128 in recording media 112 (FIG. 1), the program guide data 300 with the associated advertisement data corresponding to the program can also be recorded so that the programming associated advertising can be recalled when the program is viewed from the recording.

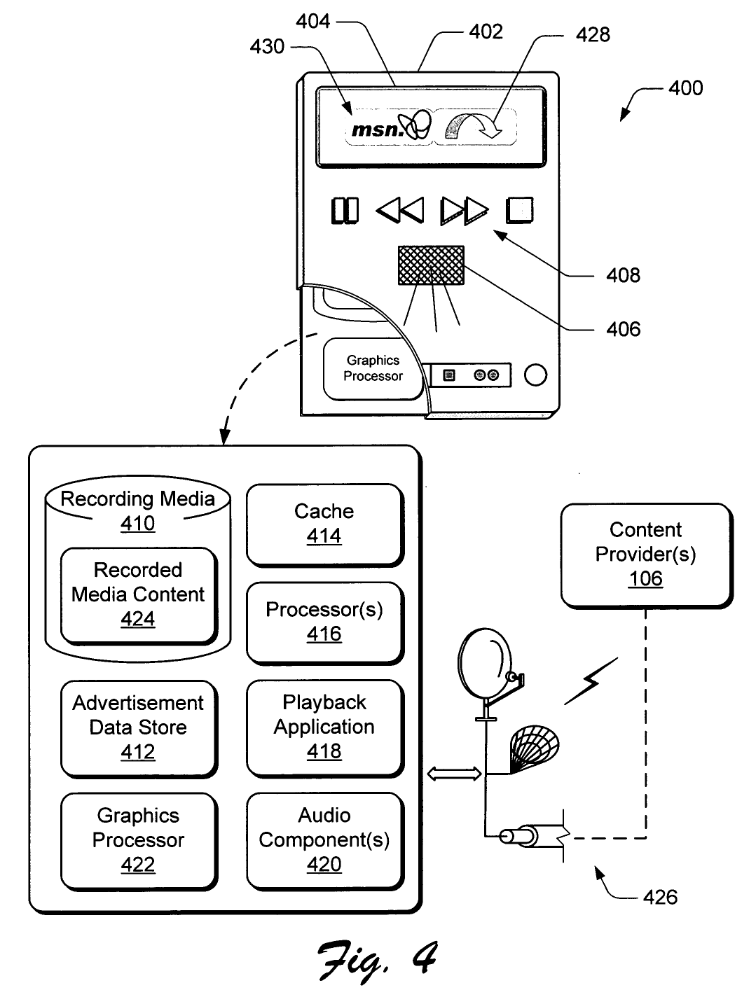

FIG. 4 illustrates an exemplary implementation 400 of media content navigation associated advertising. The exemplary implementation 400 is an example of a media content playback system implemented as an audio playback device 402 (optionally portable), such as an MP3 player or similar device. The audio playback device 402 includes an integrated display 404, an audio rendering device 406 (e.g., a speaker), and selectable controls 408 that are user-selectable to control the operation of device 402 and to control rendering audio content.

In this example, audio playback device 402 includes memory components such as a recording media 410, an advertisement data store 412, and a cache 414. Audio playback device 402 also includes one or more processors 416, a playback application 418, one or more audio components 420, and a graphics processor 422. The operational aspects of most of these components in relation to media content navigation associated advertising are described above with reference to the exemplary implementation 100 (FIG. 1). Although not shown in this example, audio playback device 402 may also be implemented with any number and combination of differing components as described above with reference to the client device 102 (FIG. 1) and as further described below with reference to the exemplary client device 602 (FIG. 6).

The processor(s) 416 (e.g., any of microprocessors, controllers, and the like) process various instructions to control the operation of audio playback device 402. Recording media 410 can be implemented as any form of fixed or removable memory component to record and maintain audio content as recorded media content 424. The audio content can be received as music, for example, from the content provider(s) 106 via various detachable transmission media 426, such as satellite transmission, radio frequency transmission, cable transmission, and/or via any number of other transmission media.

Advertisement data store 412 can be implemented as any form of a memory component to maintain, or otherwise store, advertisement data received via transmission media 426 from the one or more content providers 106. For broadcast media content, such as a broadcast music, the advertisement data corresponding to the audio can be received as one or more data packets integrated with the live feed, or data stream, of media content. Alternatively, advertisement data can be received from the content provider(s) 106 as an independent broadcast or transmission. Cache 414 is a memory component which can be implemented to maintain advertisement(s) that correspond to audio currently rendered with the audio playback device 402. Further, the cache 414 can maintain any form of an index to advertisement(s) or an advertisement playlist of one or more advertisements stored in the advertisement data store 412.

Playback application 418 can be stored as computer-executable instructions in a non-volatile memory of audio playback device 402, and can be executed with the one or more processors 416. Playback application 418 is implemented to control the playback of media content, such as music, an audible message, and the like. The one or more audio components 420 render the media content and an advertisement or an audible portion of an advertisement as audio on speaker 406. Further, the playback application 418 is implemented to receive a media content navigation input, such as from a user-selectable control 408, to generate a navigation indicator 428 for display on the integrated display 404, and to obtain an advertisement 430 to be rendered while the navigation indicator 428 is displayed, or in place of the navigation indicator 428. A media content navigation input can be received as a command to play music, skip-ahead in the music, skip-back in the music, pause the music, stop the music, record a live broadcast, and as any other audio or media content navigation input.

The playback application 418 can obtain an advertisement, such as the logo advertisement 430 and/or an audio message, from the advertisement data store 412 and/or the cache 414. Although the playback application 418 is illustrated and described as a single application, playback application 418 can be implemented as several component applications distributed to each perform one or more functions in a media content playback system. The graphics processor 422 processes navigation indicator data to display navigation indicators on the display 404, such as navigation indicator 428, and further processes advertisement data to display graphic advertisements on the display 404, such as logo advertisement 430.

Methods for media content navigation associated advertising may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

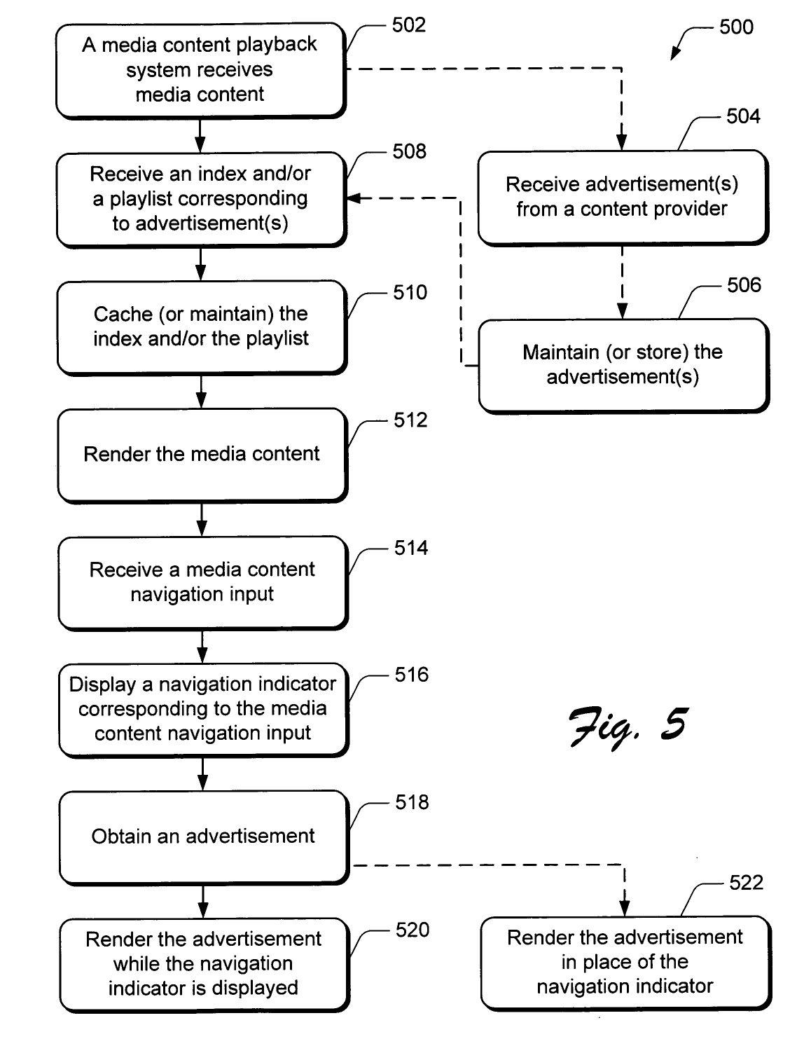

FIG. 5 illustrates a method 500 for media content navigation associated advertising. The order in which the method is described is not intended to be construed as a limitation, and any number of the described method blocks can be combined in any order to implement the method. Furthermore, the method can be implemented in any suitable hardware, software, firmware, or combination thereof.

At block 502, a media content playback system receives media content. For example, client device 102 (FIG. 1) and audio playback device 402 (FIG. 4) receives image and/or audio media content from one or more content providers 106. At block 504 (optionally), advertisement(s) are received from a content provider. For example, client device 102 and audio playback device 402 can receive advertisement data corresponding to one or more advertisements from the content provider(s) 106. The advertisement data can be received with the media content and/or can be received as an independent broadcast or transmission.

At block 506 (optionally), the advertisement(s) are maintained, or otherwise stored. For example, client device 102 maintains or stores the advertisements in advertisement data store 114, or caches the advertisements in cache 116. Similarly, audio playback device 402 maintains or stores the advertisements in advertisement data store 412, or caches the advertisements in cache 414.

At block 508, an index corresponding to an advertisement, and/or a playlist corresponding to one or more advertisements, is received. At block 510, the index and/or playlist is cached, or otherwise maintained. For example, client device 102 and audio playback device 402 can receive an index 202 (FIG. 2) and/or an advertisement playlist 204, and cache the index 202 and/or playlist 204 in cache 116 and 414, respectively.

At block 512, the media content is rendered. Rendering media content includes displaying a program on a display device, such as program 136 (FIG. 1) displayed on display device 104. Rendering media content also includes generating audio with one or more audio components, such as with speakers 138 and audio components 124 in client device 102, and with speaker 406 and audio components 420 in audio playback device 402.

At block 514, a media content navigation input is received. For example, playback application 122 (FIG. 1) in client device 102 or playback application 418 (FIG. 4) in audio playback device 402 can receive a media content navigation input, such as a command to play media content (e.g., start a program for viewing or begin an audio rendition), skip-ahead or skip-back in the media content, pause or stop the media content, and any other similar media content navigation command.

At block 516, a navigation indicator corresponding to the media content navigation input is displayed. For example, navigation indicator 142 (FIG. 1) is displayed over the program 136 on display device 104 and corresponds to a skip-ahead command of the program. Similarly, navigation indicator 428 (FIG. 4) is displayed on display 404 of the audio playback device 402 and corresponds to a skip-ahead command of the audio content.

At block 518, an advertisement is obtained. For example, playback application 122 (FIG. 1) in client device 102 can obtain an advertisement 200 (FIG. 2) from cache 116, from advertisement data store 114, or from the remote advertisement data store 132 in content provider 106. Further, the playback g application 122 can utilize an index 202 or a playlist 204 to obtain the advertisement. The advertisement can be obtained according to an order designated by the playlist, or based on a time of day, a type of the program, a program channel on which the program is broadcast, and/or any combination thereof. Similarly, playback application 418 (FIG. 4) in audio playback device 402 can obtain an advertisement 200 from cache 414 and/or from advertisement data store 412.

At block 520, the advertisement is rendered while the navigation indicator is displayed. Alternatively, the advertisement is rendered in place of the navigation indicator at block 522. The advertisement can be rendered as any form of an image, such as a still image, a sequence or series of images, a graphic, a logo, an animated logo, or a watermark, and/or as any form of audio, such as music, digital music, an audible message, a generated tone, and/or any combination of an image and audio. For example, advertisement 144 is displayed over the program 136 on display device 104 while the navigation indicator 142 is displayed.

FIG. 6 illustrates a television-based system 600 that includes an exemplary client device 602 which includes components to implement media content navigation associated advertising. Exemplary client device 602 can be implemented as client device 102 (FIG. 1) and as the exemplary audio playback device 402 (FIG. 4) with any number and combination of the differing components described herein. Exemplary client device 602 can also be implemented as a set-top box, a satellite receiver, a TV recorder with a hard disk, a digital video recorder (DVR) and playback system, a game console, an audio recording an playback system, an information appliance, and as any number of similar embodiments. System 600 also includes a display device 604 to display on-demand and broadcast programs, as well as navigation indicators and associated advertising.

Client device 602 includes one or more tuners 606 which are representative of one or more in-band tuners that tune to various frequencies or channels to receive audio signals and/or television signals, as well as an out-of-band tuner that tunes to the program channel over which program data is broadcast to client device 602. Client device 602 also includes one or more processors 608 (e.g., any of microprocessors, controllers, and the like) which process various instructions to control the operation of client device 602 and to communicate with other electronic and computing devices.

Client device 602 can be implemented with one or more memory components, examples of which include a random access memory (RAM) 610, mass storage media 612, a disk drive 614, and a non-volatile memory 616 (e.g., any one or more of a read-only memory (ROM), flash memory, EPROM, EEPROM, etc.). Disk drive 614 can include any type of magnetic or optical storage device, such as a hard disk drive, a magnetic tape, a recordable and/or rewriteable compact disc (CD), a DVD, a DVD+RW, and the like. The one or more memory components provide data storage mechanisms to store various information and/or data such as received media content, program guide data 618, recorded programs 620, configuration information for client device 602, graphical user interface information, and any other types of information and data related to operational aspects of client device 602. Alternative implementations of client device 602 can include a range of processing and memory capabilities, and may include any number of differing memory components than those illustrated in FIG. 6. For example, full-resource clients can be implemented with substantial memory and processing resources, whereas low-resource clients may have limited processing and memory capabilities.

An operating system 622 and one or more application programs 624 (such as playback application 122 shown in FIG. 1 and playback application 418 shown in FIG. 4, for example) can be stored in non-volatile memory 616 and executed on processor(s) 608 to provide a runtime environment. A runtime environment facilitates extensibility of client device 602 by allowing various interfaces to be defined that, in turn, allow application programs 624 to interact with client device 602. The application programs 624 can include a browser to browse the Web (e.g., “World Wide Web”), an email program to facilitate electronic mail, and any number of other application programs.

A program guide application 626 that executes on processor(s) 608 is also stored in non-volatile memory 616 and is implemented to process the program guide data 618. Program guide application 626 generates the program guides which enable a viewer to navigate through an onscreen display and locate broadcast programs, recorded programs, video on-demand programs and movies, interactive game selections, and other media access information or content of interest to the viewer. With program guide application 626, the television viewer can look at schedules of current and future programming, set reminders for upcoming programs, and/or enter instructions to record one or more programs.

Client device 602 further includes one or more communication interfaces 628 and a PSTN, DSL, cable, or other type of modem 630. The communication interface(s) 628 can be implemented as any one or more of a serial and/or parallel interface, as a wireless interface, any type of network interface, and as any other type of communication interface. A wireless interface enables client device 602 to receive control input commands 632 and other information from a user-operated input device, such as from a remote control device 634 or from another infrared (IR), 802.11, Bluetooth, or similar RF input device. Input devices can include a wireless keyboard or another handheld input device 636 such as a personal digital assistant (PDA), handheld computer, wireless phone, or the like.

A network interface provides a connection between client device 602 and a data communication network which allows other electronic and computing devices coupled to a common data communication network to communicate information to client device 602 via the network. Similarly, a serial and/or parallel interface provides a data communication path directly between client device 602 and another electronic or computing device to interact and communicate with the other device via any number of the various communication links. Modem 630 facilitates client device 602 communication with other electronic and computing devices via a conventional telephone line, a DSL connection, cable, and/or other type of connection.

Client device 602 also includes a content processor 638 which can include a video decoder and/or additional processors to receive, process, and decode broadcast video signals and program data, such as NTSC, PAL, SECAM, or other television system analog video signals, as well as DVB, ATSC, or other television system digital video signals. For example, content processor 638 can include an MPEG-2 or MPEG-4 (Moving Pictures Experts Group) decoder that decodes MPEG-encoded video content and/or image data. The systems described herein can be implemented for any type of video encoding format as well as for data and/or content streams that are not encoded.

Typically, video content and program data includes video data and corresponding audio data. Content processor 638 generates video and/or display content that is formatted for display on display device 604, and generates decoded audio data that is formatted for presentation by a presentation device, such as one or more speakers (not shown) in display device 604. Content processor 638 can include a display controller (not shown) that processes the video and/or display content to display corresponding images on display device 604. A display controller can be implemented as a graphics processor, microcontroller, integrated circuit, and/or similar video processing component to process the images.

Client device 602 also includes an audio and/or video output 640 that provides the audio, video, and/or display signals to television 604 or to other devices that process and/or display, or otherwise render, the audio and video data. Video signals and audio signals can be communicated from client device 602 to television 604 via an RF (radio frequency) link, S-video link, composite video link, component video link, analog audio connection, or other similar communication links.

Although shown separately, some of the components of client device 602 may be implemented in an application specific integrated circuit (ASIC). Additionally, a system bus (not shown) typically connects the various components within client device 602. A system bus can be implemented as one or more of any of several types of bus structures, including a memory bus or memory controller, a peripheral bus, an accelerated graphics port, or a local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

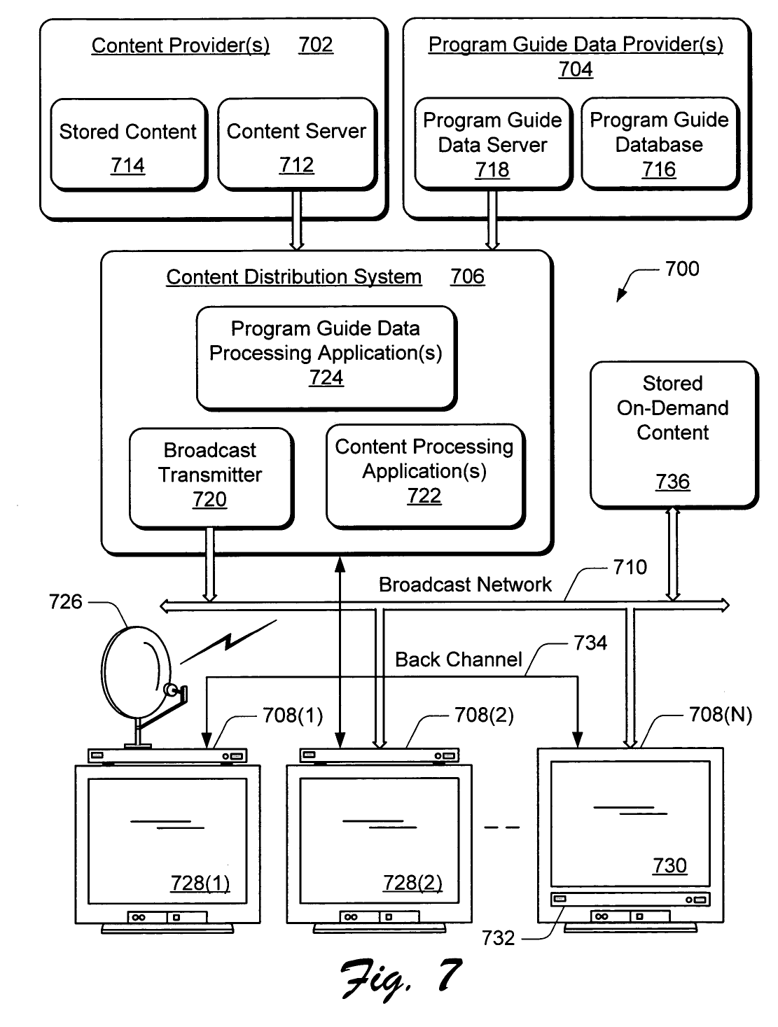

FIG. 7 illustrates an exemplary system architecture 700 in which media content navigation associated advertising can be implemented. System 700 facilitates distribution of content and program guide data to multiple viewers. The system 700 includes one or more content providers 702, one or more program guide data providers 704, a content distribution system 706, and multiple client devices 708(1), 708(2), . . . , 708(N) coupled to the content distribution system 706 via a broadcast network 710.

A content provider 702 can be implemented as a satellite operator, a network television operator, a cable operator, and the like. A content provider 702 includes a content server 712 to control distribution of stored content 714, such as movies, television programs, commercials, music, and similar audio, video, and/or image content from content provider 702 to the content distribution system 706. Additionally, content server 712 controls distribution of live content (e.g., content that was not previously stored, such as live feeds) and/or content stored at other locations to the content distribution system 706.

A program guide data provider 704 includes a program guide database 716 and a program guide data server 718. The program guide database 716 stores electronic files of program guide data which is used to generate an electronic or interactive program guide (or, “program guide”). Program guide data can include a program title, program broadcast day(s) to identify which days of the week the program will be broadcast, program start times(s) to identify a time that the program will be broadcast on the particular day or days of the week, and a program category. A program category describes the genre of a program and categorizes it as a particular program type. For example, a program can be categorized as a movie, a comedy, a sporting event, a news program, a sitcom, a talk show, or as any number of other category descriptions. Program guide data can also include program ratings, characters, descriptions, actor names, station identifiers, channel identifiers, other schedule information, and so on. Additionally, program guide data may include video on-demand content information, such as movie schedules, as well as application information, such as for interactive games, and other programming information that may be of interest to a viewer.

The program guide data server 718 processes the program guide data prior to distribution to generate a published version of the program guide data which can contain programming information for all broadcast channels and on-demand content listings for one or more days. The processing may involve any number of techniques to reduce, modify, or enhance the program data such as data compression, format modification, and the like. The program guide data server 718 controls distribution of the published version of the program guide data from a program guide data provider 704 to the content distribution system 706 using, for example, a file transfer protocol (FTP) over a TCP/IP network (e.g., Internet or Intranet). Further, the published version of the program guide data can be transmitted from program data provider 704 via a satellite and the content distribution system 706 directly to a client device 708.

Content distribution system 706 is representative of a headend service and/or program data center that provides program guide data, as well as content, to multiple subscribers (e.g., client devices 708). Each content distribution system 706 may receive a different version of the program guide data that takes into account different programming preferences and lineups. The program guide data server 718 can create different versions of the program guide data that includes those channels of relevance to respective headend services, and the content distribution system 706 transmits the program guide data to the multiple client devices 708. In one implementation, for example, content distribution system 706 utilizes a carousel file system to repeatedly broadcast the program guide data over an out-of-band (OOB) channel to the client devices 708. Alternatively, the multiple client devices 708 can receive standard, or uniform, program guide data and individually determine which program guide data to display based on the associated headend service.

Content distribution system 706 includes a broadcast transmitter 720, one or more content processing applications 722, and one or more program guide data processing applications 724. Broadcast transmitter 720 broadcasts signals, such as cable television signals, across broadcast network 710. Broadcast network 710 can include a cable television network, RF, microwave, satellite, and/or data network, such as the Internet, and may also include wired or wireless transmission media using any broadcast format or broadcast protocol. Additionally, broadcast network 710 can be any type of network, using any type of network topology and any network communication protocol, and can be represented or otherwise implemented as a combination of two or more networks.

A content processing application 722 processes the content received from a content provider 702 prior to transmitting the content across broadcast network 710. Similarly, a program guide data processing application 724 processes the program guide data received from a program guide data provider 704 prior to transmitting the program guide data across broadcast network 710. A particular content processing application 722 may encode, or otherwise process, the received content into a format that is understood by the multiple client devices 708 which are coupled to broadcast network 710. Although FIG. 7 shows a single content provider 702, a single program guide data provider 704, and a single content distribution system 706, exemplary system 700 can include any number of content providers and/or program guide data providers coupled to any number of content distribution systems.

Client devices 708 can be implemented in a number of ways. For example, a client device 708(1) receives broadcast content from a satellite-based transmitter via a satellite dish 726. Client device 708(1) is also referred to as a set-top box or a satellite receiving device. Client device 708(1) is coupled to a television 728(1) for presenting the content received by the client device (e.g., audio data, video data, and image data), as well as a graphical user interface. A particular client device 708 can be coupled to any number of televisions 728 and/or similar devices that can be implemented to display or otherwise render content. Similarly, any number of client devices 708 can be coupled to a single television 728.

Client device 708(2) is also coupled to receive broadcast content from broadcast network 710 and provide the received content to associated television 728(2). Client device 708(N) is an example of a combination television 730 and integrated set-top box 732. In this example, the various components and functionality of the set-top box are integrated into the television, rather than using two separate devices. The set-top box integrated into the television can receive broadcast signals via a satellite dish (similar to satellite dish 726) and/or via broadcast network 710. In alternate implementations, client devices 708 may receive broadcast signals via the Internet or any other broadcast medium, such as back channel 734 which can be implemented as an Internet protocol (IP) connection or as other protocol connections using a modem connection and conventional telephone line, for example. Further, back channel 734 provides an alternate communication link between each of the client devices 708, and between the client devices 708 and the content distribution system 706.

The exemplary system 700 also includes stored on-demand content 736, such as video on-demand (VOD) movie content. The stored on-demand content 736 can be viewed with a television 728 via a client device 708 through an onscreen movie guide, for example, and a viewer can enter instructions to stream a particular movie, or other stored content, to a corresponding client device 708.

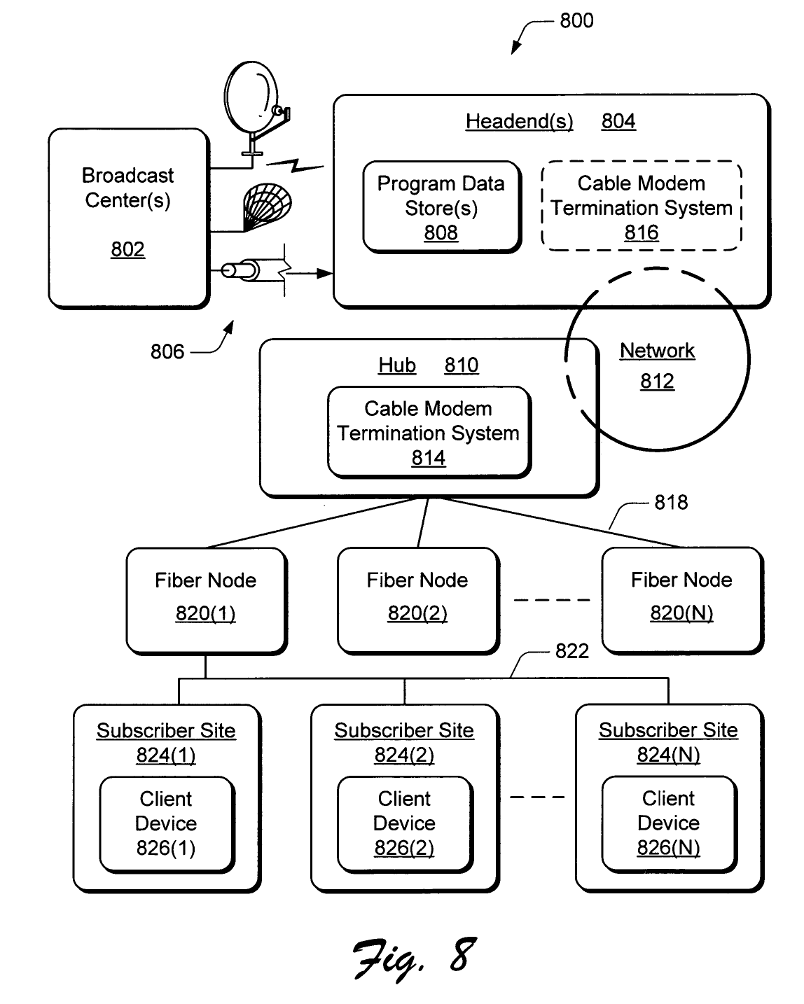

FIG. 8 illustrates an exemplary broadcast video distribution architecture 800 in which media content navigation associated advertising can be implemented. One or more broadcast centers 802 provide broadcast content to one or more headends 804 via one or more transmission media 806. Each broadcast center 802 and headend 804 interfaces with the various transmission media 806, such as a satellite transmission, radio frequency transmission, cable transmission, and/or via any number of other transmission media. A broadcast center 802 can be implemented as a satellite operator, a network television operator, a cable operator, and the like.

A headend 804 includes one or more program data stores 808 to record the broadcast content that is received via a transmission media 806. The broadcast content can be stored, or otherwise recorded, while the broadcast content is in a compressed format, for example, in order to facilitate the ongoing storage of the content over days, weeks, or even indefinitely. The compression format may comport with a Moving Pictures Expert Group (MPEG) algorithm, such as MPEG-2, MPEG-4, and so forth. Other compression technologies may alternatively be employed, such as Microsoft Windows® Media, Advanced Simple Profile (ASP), Cintak, and the like.

A headend 804 and a hub 810 communicate across a network 812 which can be implemented as a fiber ring that may operate with a packet-based protocol, such as Internet protocol (IP), IP over asynchronous transfer mode (ATM), and other protocols. Packets can therefore be communicated between headend 804 and hub 810 which includes a cable modem termination system 814 for terminating communications from downstream cable modems. Alternatively, headend 804 may include a cable modem termination system 816 to terminate the cable modem communications. Although only one hub 810 is illustrated in architecture 800, a headend 804 can distribute broadcast content to multiple hubs 810 via network 812.

Hub 810 distributes the broadcast content over fiber lines 818 to one or more fiber nodes 820(1), 820(2) . . . 820(N). Each fiber node 820 has one or more coaxial lines 822 over which the broadcast content is output, and each coaxial line 822 includes coaxial line drops to multiple subscriber sites 824(1), 824(2), . . . 824(N). Each subscriber site 824 includes one or more client devices 826(1), 826(2), . . . 826(N), respectively. Subscriber sites 824 can be homes, businesses, and the like with each subscriber site 824 including multiple client devices 826 that are each directly or indirectly interfacing with one or more of coaxial lines 822. Client devices 826 may be computers, set-top boxes of varying capabilities, hand-held and/or portable electronic devices, digital televisions, and so forth. Each client device 826 may include an integrated video screen or may be coupled to a video screen.

Although media content navigation associated advertising has been described in language specific to structural features and/or methods, it is to be understood that the subject of the appended claims is not necessarily limited to the specific features or methods described. Rather, the specific features and methods are disclosed as exemplary implementations of media content navigation associated advertising.

1. A media content playback system, comprising:
a graphics processor configured to process media content for display;
a playback application configured to:
receive a media content navigation input; and
obtain an advertisement to be rendered when the media content navigation input is received.

2. A media content playback system as recited in claim 1, further comprising one or more audio components configured to render the advertisement as audio.

3. A media content playback system as recited in claim 1, further comprising one or more audio components configured to render the advertisement as an audible message.

4. A media content playback system as recited in claim 1, wherein the graphics processor is further configured to process advertisement data to display the advertisement as a logo.

5. A media content playback system as recited in claim 1, wherein the graphics processor is further configured to process advertisement data to display the advertisement as an animated logo.

6. A media content playback system as recited in claim 1, wherein the playback application is further configured to generate a navigation indicator for display on the media content, the navigation indicator corresponding to the media content navigation input.

7. A media content playback system as recited in claim 1, wherein:
the playback application is further configured to generate a navigation indicator for display on the media content, the navigation indicator corresponding to the media content navigation input; and
the graphics processor is further configured to process advertisement data to display the advertisement while the navigation indicator is displayed.

8. A media content playback system as recited in claim 1, further comprising one or more audio components configured to render audio, and wherein:
the advertisement includes a logo and corresponding audio;
the graphics processor is further configured to process advertisement data to display the logo; and
the one or more audio components are further configured to render the corresponding audio while the logo is displayed.

9. A media content playback system as recited in claim 1, wherein:
the graphics processor is further configured to process the media content to display a program on a display device;
the playback application is further configured to:
receive the media content navigation input as a command to skip-ahead in the program;
generate a navigation indicator for display over the program on the display device; and
obtain the advertisement for display over the program on the display device while the navigation indicator is displayed.

10. A media content playback system as recited in claim 1, wherein:
the graphics processor is further configured to process the media content to display a program on a display device;
the playback application is further configured to:
receive the media content navigation input as at least one of a command to play the program, skip-ahead in the program, skip-back in the program, pause the program, and stop the program;
generate a navigation indicator for display over the program on the display device; and
obtain the advertisement for display over the program on the display device while the navigation indicator is displayed.

11. A media content playback system as recited in claim 1, wherein the playback application is further configured to obtain the advertisement from an advertisement data store.

12. A media content playback system as recited in claim 1, wherein the playback application is further configured to obtain the advertisement from a content provider.

13. A media content playback system as recited in claim 1, wherein the playback application is further configured to obtain the advertisement from program guide data.

14. A media content playback system as recited in claim 1, further comprising a cache configured to maintain the advertisement when received as additional content integrated with the media content, and wherein the playback application is further configured to obtain the advertisement from the cache to render the advertisement.

15. A media content playback system as recited in claim 1, further comprising a cache configured to maintain an index to the advertisement, and wherein the playback application is further configured to utilize the index to obtain the advertisement from an advertisement data store to render the advertisement.

16. A media content playback system as recited in claim 1, further comprising a cache configured to maintain an index to the advertisement, and wherein the playback application is further configured to utilize the index to obtain the advertisement from a content provider to render the advertisement.

17. A media content playback system as recited in claim 1, further comprising:
an advertisement store configured to maintain the advertisement;
a cache configured to maintain an index to the advertisement, the index received with the media content; and
wherein the playback application is further configured to utilize the index to obtain the advertisement from the advertisement store to render the advertisement.

18. A media content playback system as recited in claim 1, further comprising an advertisement store configured to maintain one or more advertisements, and wherein:
the graphics processor is further configured to process the media content to display a program on a display device; and
the playback application is further configured to obtain the advertisement from the one or more advertisements based on at least one of a time of day, a type of the program, and a program channel on which the program is broadcast.

19. A media content playback system as recited in claim 1, further comprising:
an advertisement store configured to maintain one or more advertisements;
a cache configured to maintain a playlist that designates an order in which the one or more advertisements are to be rendered; and
wherein the playback application is further configured to obtain the advertisement from the one or more advertisements according to the playlist.

20. A television-based client device comprising the media content playback system as recited in claim 1.

21. A digital video recorder comprising the media content playback system as recited in claim 1.

22. A media content playback system, comprising:
one or more audio components configured to render media content as audio;
a playback application configured to:
receive a media content navigation input;
generate a navigation indicator for display, the navigation indicator corresponding to the media content navigation input; and
obtain an advertisement to be rendered while the navigation indicator is displayed.

23. A media content playback system as recited in claim 22, wherein the one or more audio components are further configured to render the advertisement as audio.

24. A media content playback system as recited in claim 22, wherein the one or more audio components are further configured to render the advertisement as an audible message.

25. A media content playback system as recited in claim 22, further comprising a graphics processor configured to process advertisement data to display the advertisement as a logo.

26. A media content playback system as recited in claim 22, further comprising a graphics processor configured to process advertisement data to display the advertisement as an animated logo.

27. A media content playback system as recited in claim 22, further comprising a graphics processor configured to process advertisement data to display a logo, and wherein:
the advertisement includes the logo and corresponding audio; and
the one or more audio components are further configured to render the corresponding audio while the logo is displayed.

28. A media content playback system as recited in claim 22, wherein:
the one or more audio components are further configured to render the media content as music; and
the playback application is further configured to receive the media content navigation input as at least one of a command to play the music, skip-ahead in the music, skip-back in the music, pause the music, and stop the music.

29. A media content playback system as recited in claim 22, further comprising a cache configured to maintain the advertisement when received as additional content integrated with the media content, and wherein the playback application is further configured to obtain the advertisement from the cache to render the advertisement.

30. A media content playback system as recited in claim 22, further comprising a cache configured to maintain an index to the advertisement, and wherein the playback application is further configured to utilize the index to obtain the advertisement from an advertisement data store to render the advertisement.

31. A media content playback system as recited in claim 22, further comprising a cache configured to maintain an index to the advertisement, and wherein the playback application is further configured to utilize the index to obtain the advertisement from a content server to render the advertisement.

32. A media content playback system as recited in claim 22, further comprising:
an advertisement store configured to maintain the advertisement;
a cache configured to maintain an index to the advertisement; and
wherein the playback application is further configured to utilize the index to obtain the advertisement from the advertisement store to render the advertisement.

33. A portable client device comprising the media content playback system as recited in claim 22.

34. A digital video recorder comprising the media content playback system as recited in claim 22.

35. A content provider, comprising:
an advertisement data store configured to maintain one or more advertisements corresponding to media content navigation;
an advertisement distribution application configured to:
receive a request for an advertisement associated with a media content navigation input;
obtain the advertisement from the advertisement data store; and
communicate the advertisement to a client device for display with a navigation indicator that corresponds to the media content navigation input.

36. A content provider as recited in claim 35, wherein the advertisement distribution application is further configured to receive the request as an index to the advertisement.

37. A content provider as recited in claim 35, further comprising:
a content server configured to:
communicate media content to the client device;
communicate an index to the advertisement to the client device; and
wherein the advertisement distribution application is further configured to receive the request as the index to the advertisement.

38. A content provider as recited in claim 35, further comprising:
a content server configured to:
communicate media content to the client device;
communicate an advertisement playlist to the client device; and
wherein the advertisement distribution application is further configured to receive the request as an index of the advertisement playlist.

39. A content provider as recited in claim 35, further comprising a content server configured to:
communicate media content to the client device; and
communicate the advertisement to the client device based on at least one of a time of day and a type of the media content.

40. A method, comprising:
maintaining one or more advertisements corresponding to media content navigation;
receiving a request for an advertisement associated with a media content navigation input;
obtaining the advertisement from the advertisement data store; and
communicating the advertisement to a client device for display with a navigation indicator that corresponds to the media content navigation input.

41. A method as recited in claim 40, wherein receiving the request includes receiving the request as an index to the advertisement.

42. A method as recited in claim 40, further comprising:
communicating media content to the client device;
communicating an index to the advertisement to the client device; and
wherein receiving the request includes receiving the request as the index to the advertisement.

43. A method as recited in claim 40, further comprising:
communicating media content to the client device;
communicating an advertisement playlist to the client device; and
wherein receiving the request includes receiving the request as an index of the advertisement playlist.

44. A method as recited in claim 40, further comprising:
communicating media content to the client device; and
communicating the advertisement to the client device based on at least one of a time of day and a type of the media content.

45. A method, comprising:
rendering media content;
receiving a media content navigation input;
displaying a navigation indicator corresponding to the media content navigation input; and
rendering an advertisement in addition to the media content while the navigation indicator is displayed.

46. A method as recited in claim 45, wherein the advertisement is rendered as audio.

47. A method as recited in claim 45, wherein the advertisement is rendered as an audible message.

48. A method as recited in claim 45, wherein rendering the advertisement includes displaying the advertisement as a logo.

49. A method as recited in claim 45, wherein rendering the advertisement includes displaying the advertisement as an animated logo.

50. A method as recited in claim 45, wherein rendering the advertisement includes displaying the advertisement as a logo and rendering an audible message corresponding to the logo.

51. A method as recited in claim 45, wherein:
rendering the media content includes displaying a program on a display device;
the media content navigation input is received as a command to skip-ahead in the program;
the navigation indicator is displayed over the program on the display device; and
rendering the advertisement includes displaying the advertisement over the program on the display device while the navigation indicator is displayed.

52. A method as recited in claim 45, wherein:
rendering the media content includes displaying a program on a display device;
the media content navigation input is received as at least one of a command to play the program, skip-ahead in the program, skip-back in the program, pause the program, and stop the program;
the navigation indicator is displayed over the program on the display device; and
rendering the advertisement includes displaying the advertisement over the program on the display device while the navigation indicator is displayed.

53. A method as recited in claim 45, further comprising:
receiving the advertisement from a content provider;
caching the advertisement; and
obtaining the advertisement from the cache to render the advertisement.

54. A method as recited in claim 45, further comprising:
receiving an index corresponding to the advertisement;
caching the index; and
utilizing the index to obtain the advertisement from an advertisement data store to render the advertisement.

55. A method as recited in claim 45, further comprising:
receiving an index corresponding to the advertisement;
caching the index; and
utilizing the index to obtain the advertisement from a content provider to render the advertisement.

56. A method as recited in claim 45, further comprising:
receiving a playlist of advertisements;
caching the playlist; and
utilizing the playlist to obtain the advertisement from an advertisement data store to render the advertisement.

57. A method as recited in claim 45, further comprising:
receiving a playlist of advertisements;
caching the playlist; and
utilizing the playlist to obtain the advertisement from a content provider to render the advertisement.

58. A method as recited in claim 45, further comprising:
receiving one or more advertisements;
receiving a playlist that designates an order in which the one or more advertisements are to be rendered; and
obtaining the advertisement from the one or more advertisements according to the playlist.

59. A method as recited in claim 45, further comprising:
receiving one or more advertisements;
maintaining the one or more advertisements in an advertisement data store;
obtaining the advertisement from the advertisement data store to render the advertisement; and
wherein the media content is rendered as a program and the advertisement is obtained based on at least one of a time of day, a type of the program, and a program channel on which the program is broadcast.

60. A method as recited in claim 45, further comprising:
receiving an additional media content navigation input;
displaying an additional navigation indicator corresponding to the additional media content navigation input; and
rendering the advertisement while the additional navigation indicator is displayed.

61. A method as recited in claim 45, further comprising:
receiving an additional media content navigation input;
displaying an additional navigation indicator corresponding to the additional media content navigation input; and
rendering a second advertisement while the additional navigation indicator is displayed.

62. One or more computer-readable media comprising computer executable instructions that, when executed, direct a television-based client device to perform the method of claim 45.

63. One or more computer-readable media comprising computer executable instructions that, when executed, direct a digital video recorder to perform the method of claim 45.

64. One or more computer-readable media comprising computer executable instructions that, when executed, direct a device to:
display a program on a display device;
display a navigation indicator on the display device when a media content navigation input is received; and
render an advertisement in addition to the media content while the navigation indicator is displayed.

65. One or more computer-readable media as recited in claim 64, further comprising computer executable instructions that, when executed, direct the client device to render the advertisement as audio.

66. One or more computer-readable media as recited in claim 64, further comprising computer executable instructions that, when executed, direct the client device to render the advertisement as an audible message.

67. One or more computer-readable media as recited in claim 64, further comprising computer executable instructions that, when executed, direct the client device to render the advertisement as a logo displayed on the display device.

68. One or more computer-readable media as recited in claim 64, further comprising computer executable instructions that, when executed, direct the client device to render the advertisement as an animated logo displayed on the display device.

69. One or more computer-readable media as recited in claim 64, further comprising computer executable instructions that, when executed, direct the client device to display the navigation indicator when the media content navigation input is received as at least one of a command to play the program, skip-ahead in the program, skip-back in the program, pause the program, and stop the program.

70. One or more computer-readable media as recited in claim 64, further comprising computer executable instructions that, when executed, direct the client device to cache the advertisement when the advertisement is received from a content provider, and obtain the advertisement from the cache to render the advertisement.

71. One or more computer-readable media as recited in claim 64, further comprising computer executable instructions that, when executed, direct the client device to cache an index corresponding to the advertisement, and utilize the index to obtain the advertisement from an advertisement data store to render the advertisement.

72. One or more computer-readable media as recited in claim 64, further comprising computer executable instructions that, when executed, direct the client device to cache an index corresponding to the advertisement, and utilize the index to obtain the advertisement from a content provider to render the advertisement.

73. One or more computer-readable media as recited in claim 64, further comprising computer executable instructions that, when executed, direct the client device to cache a playlist of advertisements, and utilize the playlist to obtain the advertisement from an advertisement data store to render the advertisement.

74. One or more computer-readable media as recited in claim 64, further comprising computer executable instructions that, when executed, direct the client device to cache a playlist of advertisements, and utilize the playlist to obtain the advertisement from a content provider to render the advertisement.

75. One or more computer-readable media as recited in claim 64, further comprising computer executable instructions that, when executed, direct the client device to obtain the advertisement based on at least one of a time of day, a type of the program, and a program channel on which the program is broadcast.
